(19) United States
(12) Patent Application Publication
(10) Pub. No.: US 2008/0183511 A1
(43) Pub. Date: Jul. 31, 2008

(54) Property Management Solution

(76) Inventors: Brad Handler, Denver, CO (US); Brent Handler, Denver, CO (US); Tom Filippini, Denver, CO (US); Charles Livingston, Denver, CO (US); Ryan Prichard, Denver, CO (US)

Correspondence Address: CERMAK KENEALY & VAIDYA, LLP, 515 EAST BRADDOCK RD SUITE B, Alexandria, VA, 22314, US

(21) Appl. No.: 11/847,065

(22) Filed: Aug. 29, 2007

Related U.S. Application Data
(63) Continuation-in-part of application No. 10/892,478, filed on Jul. 16, 2004.
(60) Provisional application No. 60/487,256, filed on Jul. 16, 2003.
(60) Provisional application No. 60/840,696, filed on Aug. 29, 2006.

(51) Int. Cl. G06Q 10/00; G06Q 30/00

(52) U.S. Cl. 705/5

(57) ABSTRACT

The invention provides a residence management solution for offering, reserving and managing accommodations. The invention further provides a system and methods for providing various member services to members of a Destination Club. The invention also provides an integrated on-line system for carrying out functions associated with such a residence management solution, including the application process and the reservation process. The invention further provides a system and methods for determining the availability of properties based upon parameters selected by a member and displaying properties that exactly match and closely match the selected parameters.

### CROSS REFERENCE TO RELATED APPLICATION

This application is a Continuation-In-Part (CIP) application claiming priority under 35 U.S.C. §120 to co-pending commonly assigned U.S. patent application Ser. No. 10/892,478 filed on Jul. 16, 2004 which claims priority under 35 U.S.C. §119(e) to U.S. Provisional Application No. 60/487,256 filed on Jul. 16, 2003, the disclosures of both of which are incorporated herein by reference. This application also claims priority under 35 U.S.C. 119(e) to U.S. Provisional Application No. 60/840,696 filed on Aug. 29, 2006, the disclosure if which is also incorporated herein by reference.

### BACKGROUND OF THE INVENTION

1. Field of the Invention

The invention relates to a system and methods for managing real properties, and more particularly, to a system and methods for managing the offering, reserving and use of real properties by a select group of participants.

2. Discussion of the Related Art

Conventional methodologies for the acquisition of real properties involve buyers and sellers participating in a real estate market. Buyers typically seek properties that may be for sale by an owner or through brokers and/or real estate agents. A buyer will typically be evaluated to determine whether he or she meets the qualifications for purchasing a property that he or she has selected. Buyers can become aware of properties that are available for sale through a variety of mechanisms, including broker listings, as well as postings on the Internet or in newspapers.

Properties offered for a limited amount of time, such as vacation properties, occupy a unique niche in the real estate market. Such properties have special management requirements. There are currently several plan categories for managing the use of vacation properties in the travel industry, and more particularly in the luxury travel industry. General plan categories include, for example: timeshares; second home ownership; fractional ownership or a private residence club; and luxury hotel or home rentals.

Timeshare programs are one of the most common types of vacation property management plans. A timeshare program generally limits purchasers to a specific deeded interest in a single property for a particular week(s) of the year. With purchasers buying a period of time per year in a property, the ratio of owners to a specific property is typically very high, i.e., approximately 50 to 1. With a large number of owners attempting to use a property throughout a given year, owners are typically required to use the property during an assigned period, or attempt to trade time with other owners of the same property.

In an effort to allow owners of timeshares the opportunity to use a property other than the one in which they purchased a share, many timeshare operators have now given owners “exchange rights” granting them privileges at different locations throughout the world. These exchange rights require managing the complex trading scenarios available to the timeshare owners. Additionally, some operators have also implemented “point systems,” whereby timeshare owners can trade their “weeks” for other properties within a specific group of properties, again, requiring management of a points system. In addition to complicated exchange and trading programs, timeshare owners must generally schedule months to years in advance to take advantage of any available trades or exchanges. In general, timeshares are expensive to own and present various logistical problems.

As an alternative to a timeshares, some travelers purchase second homes for use as vacation homes. Generally, second homes are operated and maintained by the owner, or by a third-party manager or management firm through a management agreement. When a third-party manager is used, the individual manager or management company maintains the property to the owner's specifications. Upon request by a property owner, the property manager may lease the property on a short term basis. Such leasing function often includes marketing the property for potential rental, screening potential renters and billing and accounting related to the rentals.

Vacation properties owned by a single party often allow for the rental of the property when it is not in use by the owner. Renting a second home to other parties can allow the owner to recover a portion of the costs associated with a property and its ownership during periods when it is not being used by the owner. However, if used as a part-time rental property, the owner must also schedule his or her own vacation time in the property around the schedule of those renting the unit. While ownership of a second home may be a viable option for those at the highest asset or income levels, it is typically an unsatisfactory solution for those owners who are unable to use the homes for a significant portion of the year. Thus, many potential vacation home buyers avoid this particular market because they are reluctant to incur the costs and responsibilities of an additional home. Furthermore, many vacation travelers would prefer to have the ability to choose among multiple locations rather than being restricted to one single location.

Another option for ownership or use of a vacation property is the ownership of a luxury vacation property by a group of unrelated or unaffiliated investors who pool their capital to purchase a vacation property. These properties are marketed and managed by an independent third party and these plans are often referred to as fractional ownership clubs or private residence clubs. Fractional ownership is generally designed to more closely reflect a buyer's actual budget, probable usage, and needs and desires for a vacation home, and generally does not have the same restrictions imposed by a timeshare. While fractional ownership plans vary significantly, they are often more flexible than timeshares and may include high-quality services and amenities. Luxury fractional property ownerships attract the truly affluent because they allow for the benefits of ownership but at a reduced cost that is more in line with the actual use of the property.

Nevertheless, like timeshares, fractional ownership is still generally limited to the use of a single property and, as with whole ownership, the cost associated with management and maintenance of the property is often the responsibility of the fractional property owners. In addition, due to the increased number of owners per property, owners per property ratios typically exceed 12:1, fractional ownership sometimes requires coordination with the other fractional owners of the same property, even in cases where there is not an established relationship between the owners. Because the fractional operators divide the property into fractions in an attempt to sell nearly 100 percent of the available time in each unit, the resulting reservation policies associated with usage are prohibitively complex.

Luxury vacation travelers may also opt to rent hotel rooms, homes or villas at various vacation resorts. This strategy allows greater flexibility with respect to location of vacation travel with significant amenities and services and does not have the costs associated with ownership of a property. However, costs of luxury rentals are increasing annually at a rate significantly higher than that of inflation. Furthermore, rental properties, particularly those in popular areas, are requiring reservations months, and in some cases years, in advance. Hotels and rentals also lose a sense of home for vacationers wishing to instill a sense of consistency in their vacation travel by returning to a specific residence each time they vacation in a particular location.

Each of the property acquisition models described above have their own shortcomings and management difficulties. These include difficulty tracking the availability of such properties, difficulty allocating the properties among interested travelers, difficulty maintaining the properties and difficulty delivering various services to travelers. Such difficulties can impact the ability to efficiently notify travelers of available properties, efficiently take and honor reservations and offer high quality service and support to travelers. Thus, it would be desirable to provide a vacation residence model that overcomes these difficulties and efficiently manages the offering of vacation properties, the reservation of those properties and the delivery of services to travelers using such properties.

### SUMMARY OF THE INVENTION

The invention provides an alternative to the traditional vacation models described above. The invention includes a Destination Club model for the management of real properties for leisure travelers. The Destination Club model includes a management company that manages a portfolio of select properties. These properties are selected based upon their location, amenities, as well as other factors. The Destination Club model allows individuals to become members of the Destination Club which allows them access to the portfolio of vacation and recreational properties located in a wide array of destinations in exchange for an initial partially or fully refundable membership deposit and annual dues. Different membership plans allow individual consumers to select the number of usage days, advance reservations, holiday reservations and related parties who can travel to the residences. Destination Club members receive not only access to residences in the portfolio but also the ability to use amenities related to the residence such as golf, dining facilities, and spas as if those members actually owned the homes. In addition, Destination Club members receive a range of services while using the homes including property management, housekeeping, concierge and vacation planning services. Of course, greater availability of membership options and increased service levels present significant administrative and servicing challenges. Existing property management systems are not capable for addressing the unique challenges associated with managing properties in a Destination Club. For example, existing reservation systems have proven inadequate to manage the allocation of residence usage by members and delivery of services offered by Destination Clubs. Thus, the invention provides a unique system and methods for reserving and managing properties that are part of a Destination Club model. While the invention was created to address property management issues in the burgeoning Destination Club industry, it also has applications throughout the vacation property and other property management space.

Accordingly, the present invention provides a residence management solution that allows the owner/operator of a portfolio of vacation residences, and particularly a Destination Club, to manage a membership application process, a member reservation process, member usage of the residences, distribution of services to the residences and members and a communications platform for members and residence managers. Thus, the property management solution in accordance with the invention performs various functions, including, a travel agency function which can determine the availability of residences and coordinate reservations, a resort operations function which can provide various concierge services to members, including preparing itineraries, a portfolio management function which coordinates the management of the portfolio of residences and a communications function which facilitates an on-line communications and the delivery of services to and between members, sales agents and concierges.

According to an embodiment of the present invention, a vacation residence management solution is provided whereby a residence management company creates a portfolio of vacation properties. The residence management company makes the portfolio of properties available for use by members of a membership plan. Members may purchase various membership plans that offer varying levels of service levels.

As noted above, Destination Club members are able to choose among different membership levels. Each membership level may include a specified number of days of use which may be split into a certain number of advanced reservations and a specified number of space-available days of use. Memberships are available within the plan based upon maintaining a ratio of properties to members and are awarded only after a potential member successfully completes a membership evaluation process. Members are selected from a pool of applicants who meet certain predetermined criteria. Each member pays a partially refundable membership fee and annual membership dues.

The vacation residence management company may own a portfolio of vacation properties with no ownership interest passing to the members. A member may reserve a residence within the portfolio of vacation properties pursuant to limitations of that member's membership level. A member may use advanced reservations by reserving a residence for a specified number of days in advance. With an advanced reservation, in the event a residence is not available, the vacation residence management company may reserve a similar residence at no cost to the member. A member may use space-available weeks by requesting a residence within a space-available reservation time according to their membership profile. For space-available time, no effort will be made to locate similar accommodations for the member.

The vacation residence management company maintains a membership to residence ratio and in addition, may follow geographic dispersion guidelines to ensure that members are able to gain easy access to at least some of the residences in the vacation property portfolio.

The invention further provides a comprehensive system that allows members to take advantage of numerous web-based functions. Once an applicant becomes a member, a profile is created for that member. The profile may include such information as a member's membership level, his or her destination preferences, lifestyle preferences and other information that will assist with providing members with the most efficient service. A member can then view and learn more about residences, search for available residences and book desired residences. The residence management staff and residence concierges also have access to member information so that they can assist members with selecting and reserving properties, as well as providing various services to members once they check into the residences. The system in accordance with the invention also includes a reservations decisioning engine that optimizes the selection and booking of properties so as to maximize the likelihood that members will receive their preferred choice of properties, while also minimizing vacancies.

The invention also provides a system and methods that present a member with both a requested reservation as well as a listing of ‘close match’ residences that closely match the residences requested by the member. Close match residences provide the members with alternatives in the event that their first residence choice is booked. Close matches determinations are based upon a variety of factors, including, the similarity between requested residence and the ‘close match’ residence as it relates to: geographical/weather similarity, similarity of amenties, similarity in residence size (i.e., number of rooms), similarity in requested dates of reservation, etc.

The invention also provides for a system that determines the availability of residences meeting a member's reservation request criteria. According to one embodiment of the invention, there are four types of reservations, space available, advanced reservation, non-priority holiday and priority holiday. Each of these types of reservation requests have different rules associated with them, including how far in advance such a reservation request can be made, whether the reservation is guaranteed, etc. In one embodiment of the invention, each member's membership contract provides them with a certain allotment of each of the four types of reservations (space available, advanced reservation, non-priority holiday and priority holiday).

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof, as well as the appended drawings.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a block diagram of the system for managing properties in accordance with an embodiment of the invention;

FIG. 2 shows a flowchart providing an overview of the process for reserving residences in accordance with an embodiment of the invention;

FIG. 3 is a screen shot presented to a member seeking more information about residences;

FIG. 4 illustrates a sample screen shot of a specific destination chosen by a user;

FIG. 5 is a screen shot of a location map displayed to a member;

FIG. 6 is a screen shot illustrating images of a selected destination;

FIG. 7 is a screen shot illustrating an interface presented to a member seeking to make a reservation;

FIG. 8 is a screen shot of a calendar displayed to members after making a destination choice;

FIG. 9 is a is screen shot after a member has selected arrival and departure dates;

FIG. 10 is a screen shot of a reservation summary screen;

FIG. 11 illustrates a process for determining whether a reservation request can be fulfilled;

FIG. 12 further illustrates a process for determining the availability of a residence in view of a member's preferences;

FIG. 13 is a screen shot of an interface allowing members to search the availability of certain properties;

FIG. 14 is a screen shot of the reservation information function according to an embodiment of the invention;

FIG. 15 is a screen shot of a “My Account” drop down menu according to an embodiment of the invention;

FIG. 16 is a screen shot of a club drop down menu according to an embodiment of the invention;

FIG. 17 is a screen shot of a club regions page according to an embodiment of the invention;

FIG. 18 is screen shot illustrating a concierge tab according to an embodiment of the invention;

FIG. 19 is screen shot illustrating a feature allowing tracking of charges;

FIG. 20 is a screen shot of an interface available to member services managers; and

FIG. 21 is a screen shot of an interface displayed to member service managers are they have clicked on a particular member.

### DETAILED DESCRIPTION OF THE PREFERRED EMBODIMENTS

Reference will now be made in detail to various embodiments of the present invention, examples of which are illustrated in the accompanying drawings.

Once a Destination Club or other vacation residence management company builds a portfolio of vacation residences by purchasing or leasing residences, it must develop a system for allowing members and/or other travelers to efficiently view, select, reserve and use the residences. As described above, Destination Clubs allow members to have access to a variety of residences that are part of the Destination Club's portfolio. In order to become a member of a Destination Club, an applicant must be screened and approved for membership and pay membership dues. Destination Clubs typically include a portfolio of residences and may also include amenities related to the residence, such as a golf course, private beach and/or spa. Various services may also be associated with the residence, such as housekeeping and concierge services.

In a Destination Club setting, a residence manager manages access to and use of the residences within the portfolio in accordance with the membership documents and direction of the Destination Club executive team, while a concierge assists with the delivery of day-to-day services to members.

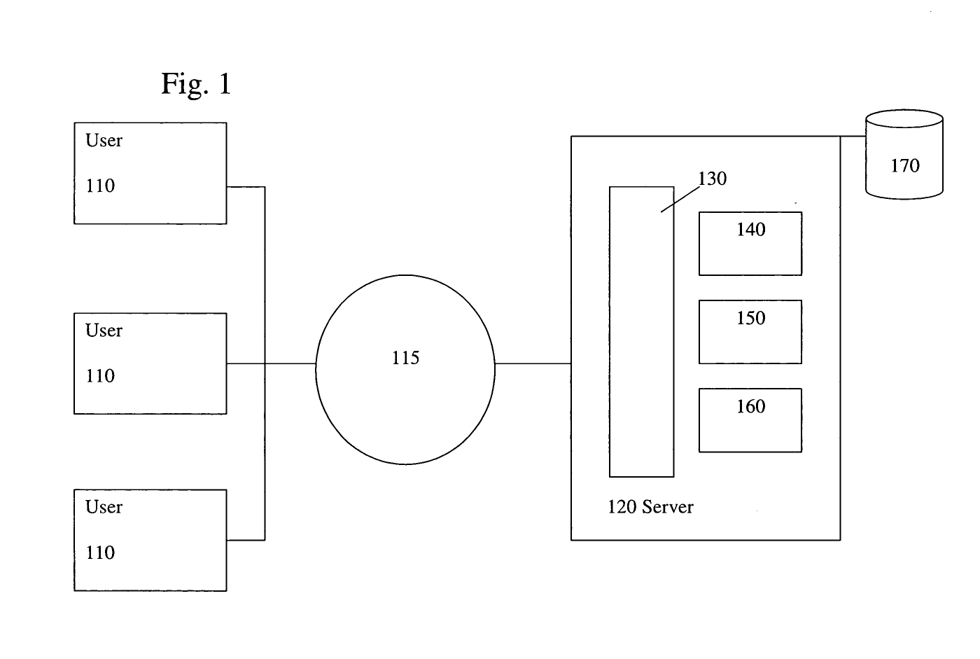

FIG. 1 shows a block diagram of a system for the management of residences, including Destination Club residences, in accordance with an embodiment of the invention. FIG. 1 shows the plurality of users 110 in communication with a residence management server 120 via a communications network 115. The communications network 115 may be any known network, including, but not limited to the Internet, a Local-Area-Network (LAN), or a Virtual Private Network (VPN). The residence management server 120 provides the functionality associated with the residence management system in accordance with the invention, including creating a member profile, facilitating member reservations, including providing information about the portfolio of residences, and facilitating communications between members, administrative and sales staff and residence level operations personnel, all of which will be described in greater detail below. As shown in FIG. 1, the server may include a webpage application 130, a communications and feedback application 140, a member profile application 150 and a reservations application 160. The residence management server 120 may also be coupled to a database 170. The residence management server 120 may also include a Read-Only-Memory (ROM), a Random-Access-Memory (RAM), a CPU, a clock and a communications port. These conventional elements are not shown in FIG. 1. The system shown in FIG. 1 allows for the management of a very large number of residences in many different locations that can be accessed by a large number of members.

A broad class of persons may constitute the users 110 including members, administrative and sales staff and residence level operations personnel such as concierges. The invention enables each of these categories of users 110 to access, via communications networks, the residence management system in accordance with the invention. In one embodiment of the invention, individuals and/or families undergo a qualification process in order to become a member. Various factors may be analyzed as part of the member qualification process, such as net worth, assets, credit score, an ability to pay an initial membership fee, as well as business and/or character references.

The users 110 can access the residence management server 120 to view and select properties, make reservations, manage reservations, track property usage, manipulate reservations, relocate travelers in the event of conflicting reservations, schedule activities, communicate with other members, administrative and sales staff and residence level operations personnel about various issues, including the properties, their amenities, services and availability. A user's 110 access to the server may vary depending upon his or her status. For example, actual members of the Destination Club will have access to a variety of services, including access to information about various properties, reservations services, including the ability to determine the availability of certain properties, access to various member's only services and forums, as well as the ability to adjust their level of ownership in the various properties. As will be described in greater detail below, the services available to members may also be governed by the type of membership plan that an individual member is part of. Users 110 who are administrative and sales staff will have access to information regarding newly available properties as well as membership profiles of each member which will assist the sales associate with locating properties and services for each member. Similarly, residence level operations personnel (concierges) will have access to various services that will allow them to assist the members, including information about property amenities and services available in close proximity to the properties. Thus, all of the functionality associated with marketing the properties, enrolling members, providing member services, including facilitating reservations and providing amenities, may reside at the residence management server 120. The webpage application 130 provides an interface between the users 110 and the communication and feedback application 140, the member profile application 150 and the reservations application 160. The database 170 coupled to the residence management server 120 stores the member profiles and residence information among other information.

The residence management server 120 will likely be maintained by the entity managing the residences. Users 110 can access the applications 140, 150 and 160 using the webpage application 130 which provides an interface for communications between the users 110 and applications 140, 150 and 160. The applications 140, 150 and 160 provide the core functionality for providing member services, member profiles, determining the availability of residences and facilitating the reservations process. Referring again to FIG. 1, the communications and feedback server 140 provides various member's only services which include the “ER Club house” feature, as will be described in greater detail below. For example, the communications and feedback server 140 provides an interface for the members to provide comments or requests for services or assistance. The communications and feedback server 140 also provides a member discussion forum where members can post information about the residences, a restaurant review function where member can inquire about restaurants located near a residence and an “ask management” function that allows members to post questions to the residence management personnel. Each of these functionalities is described in greater detail below.

The member profile application 150 shown in FIG. 1 facilitates the creation of a member profile for each member. A profile is created for each new member based upon a variety of information including a member's personal information, such as name, age, address, city of residence, education level, finances, as well as personal interests, preferences in properties and/or preferred amenities. The profile may also take into account a member's membership plan. In accordance with one embodiment of the invention, members may be broken down into different membership levels or tiers depending upon their membership plan, their finances and/or their preferences in properties and amenities. Each membership tier may be entitled to differing levels of access to the residences through different types of permitted reservations requests. According to one embodiment of the invention, there are four types of reservations requests: space available reservation requests, advanced reservation requests, non-priority holiday reservation requests and priority holiday reservation requests. According to an embodiment of the invention, space available reservations requests are reservations requests that can be made within 90 days of a requested reservation date. In other words, a member reserving a residence under a space available reservation request cannot reserve a residence more than 90 days in advance. According to one embodiment of the invention, members can also only have 2 pending space available reservation requests at a given time. This ensures that one member does not hoard residences making it difficult for other members to locate available residences. The space available type reservation request does not include a guarantee that a member's first residence choice will be available.

The advanced reservation request allows members to reserve residences at 90 days or more in advance of the requested reservation date. Thus, the advanced reservation request allows a member to reserve a residence well in advance. In one embodiment of the invention, the advanced reservation period is between 2 years and 90 days of the requested reservation date. In another embodiment of the invention, an advanced reservation request allows the member to reserve the property for only 7 days or less. In one embodiment of the invention, the advanced reservation request is guaranteed, meaning that the member is guaranteed to get a reservation at the particular residence selected using an advanced reservation request and if such a request cannot be fulfilled, then a comparable residence is located.

The non-priority holiday reservation request allows a member to reserve properties up to 180 days in advance for certain pre-determined holidays. It should be understood that this does not include all holidays, but only those designated by the management company. The non-priority holiday reservation requests are not guaranteed. As used herein holidays may include all Federal holidays as well as other holidays commonly granted by many employers, such as Christmas day.

Finally, the priority holiday reservation request allows a member to submit a reservation request for any holiday greater than 180 days in advance of arrival. All of the reservation types described above are also limited by a total number of reservation days that a member may be permitted under his or contract. For example, a member may be limited to 45 total reservation days no matter the reservation type.

Thus, as described above, each of the four types of reservations requests provide members varying abilities to make reservations. For example, the space available reservation request must be made within 90 days of the reservation date and is not guaranteed. In addition, the number of space available reservations that may be held at any given time may be limited (for example, to two space available reservations at a given time). The advanced reservation request provides the member with greater flexibility because it allows, in one embodiment, reservations from 2 years to 90 days before the reservation date and provides a guarantee. Similarly, the non-priority holiday and priority holiday requests allow members greater flexibility with respect to reserving residences. As will be described below in greater detail, the flexibility of the advanced reservation request, the non-priority holiday reservation request and the priority holiday reservation request makes them more desirable to members and thus members may be allotted only a certain number of these types of reservations per year. These allotments may be referred to as ‘tokens.’ For example, a member's contract may entitle him or her to two advanced reservation requests per year. Thus, this member may be considered to have two tokens for advanced reservation requests per year.

As an example of the various membership tiers, a top-tier membership may offer a member four advanced reservation weeks of residence use and unlimited space-available usage. Advanced reservation weeks must be reserved 90 days or more prior to arrival. Space-available time may be scheduled within ninety days of the intended departure date to a previously unreserved residence. A middle-tier membership may offer a member three advanced reservation weeks of residence use, which must be reserved 90 or more days in advance, and unlimited space-available usage when a reservation is scheduled within sixty days of the intended departure date to a previously unreserved residence. A lower-tier membership may provide two advanced reservation weeks of residence use and unlimited space-available usage when a reservation is scheduled within 30 days of the intended arrival date. It should be noted that each tier has a different initial fee and annual fee associated with it. Thus, when reservations are processed, the member's reservation tier according to their contract is evaluated to determine whether the reservation is permissible under the contract. The invention can accommodate an extensive range of membership variables, including the number of days and number of residences, who can make a reservation and the space available windows and thus the tier descriptions above are provided for exemplary purposes only. It should also be noted that the invention contemplates any number of membership tiers with the level of privileges and services varying depending upon the membership level.

The reservations application 160 includes information about each residence and its availability and also includes a decisioning engine for scheduling multiple members with their preferred residence choice while also minimizing the time during which a residence is unoccupied. The reservations application 160 also has information about alternate residences and locates alternate properties in the event that a member's first residence selection is already reserved by another member. The reservations application 160 allows members to view and learn about all of the residences and search for available residences based upon location, lifestyle and/or travel dates. The reservations application 160 may also include business rules which govern the reservations process. These business rules may be based upon the membership plan/contract and include: rules governing the time window when a member must renew a membership; rules governing what occurs with benefits accrued but not used a renewal date; rules governing guests of members (for example, do they have the same rights and privileges as members); rules governing the membership levels; rules governing the restrictions on reservations; rules governing use of properties on consecutive days; rules governing holidays; rules governing special events; rules governing advanced reservations; rules governing cancellations; and rules governing member benefits and services. Based upon the business rules and a member's reservation request, a decisioning engine (not shown) will determine the availability of the selected residence and may also provide alternative residences if a member's first residence preference is unavailable. Additional details regarding the functionality for determining the availability of residences and making reservations is discussed below.

In operation, a user 110 who is a member may access the webpage application 130 via the communications network 115 in order to gain access to the various functionality resident on the residence management server 120. For example, the member user 110 can access the reservations application 160 in order to learn about the residences and their availability and also make reservations. When determining the availability of residences upon a request by a member, the system will also consider the information about the member provided by the member profile application 150, such as a member's membership tier.

Similarly, the member user 110 can access the communications and feedback application 140 in order to access various member services including the “ER Club House” features described in greater detail below. Member users 110 can also access the member profile application 150 in order to provide information for updating their member profiles.

Users 110 who are member service staff for the property management company can also access the applications 140, 150 and 160. The member service staff can view the member profiles which may affect the availability of certain residences to a particular user. The member service staff can also field inquiries from members by utilizing the communications and feedback application 140. The member service staff can also assist members with the reservations process utilizing the reservations application 160. Similarly, residence level operations personnel such as concierges can assist members by utilizing the applications 140, 150 and 160. Such assistance may include preparing an itinerary for the members which is posted on-line and assembling all groceries and other goods requested by members prior to their arrival at the residences.

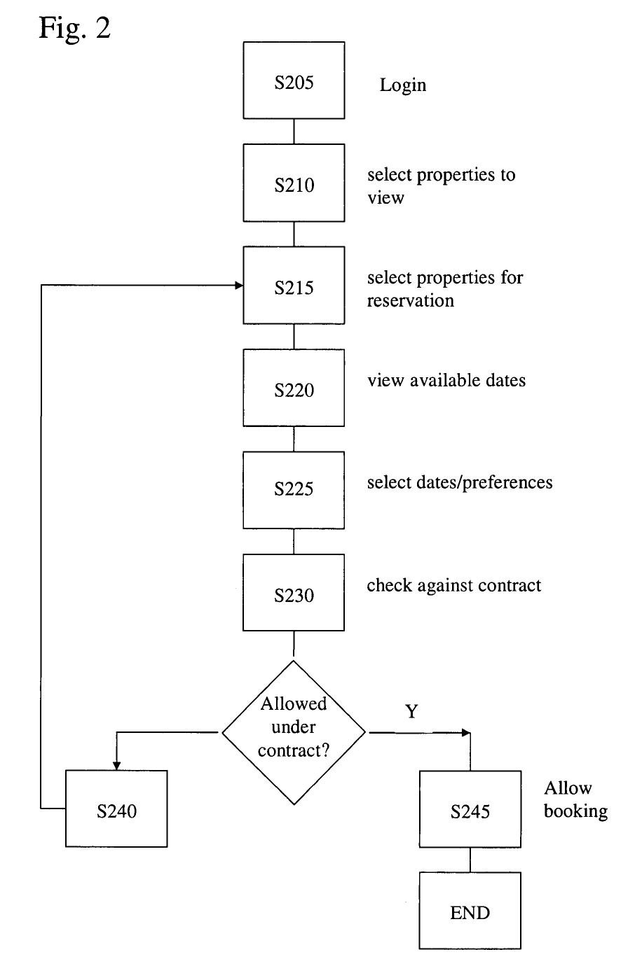

FIG. 2 illustrates the general process by which members can make reservations in accordance with an embodiment of the invention. The process begins at step S205 where a member, using a user interface, can log in and indicate an interest in viewing residences prior to making a reservation. The member is authenticated and the request is processed. The process then moves to step S210 where the member can select residences to be viewed for possible reservation. The invention provides for a variety of ways in which a member can select residences for viewing. A member can select a specific residence by name or by location or by a lifestyle grouping. A location can be selected by either submitting a specific city or country. Lifestyle groupings refer to classifying residences based upon available leisure activities and/or geographical features. For example, residence lifestyle choices may include “beach,” “skiing,” or “mountains.” The system then shows a listing of all residences that are responsive to the member's request. The member can also learn more about each residence at this point. The member can access an overview/description of the residence, view a location map for the residence, view images of the residence, view a listing of various activities and amenities available in and around the residence, view various information that might be relevant to families, including children, and view reviews and comments from other members about the residence. In this manner, the member can learn about the residence before deciding to place a reservation.

The process then moves to step S215 where the member can select a residence for reservation. At this point, the system will display a calendar for the selected residence which shows all of the days on the calendar when the residence is occupied or vacant. In one embodiment of the invention, the calendar shows days when the residence is unavailable and days when the residence has space available. In another embodiment, in addition to the unavailable and available days, the calendar also displays those days when an advanced reservation token, a holiday token and/or a special event token may be necessary in order to make a reservation. As described above, ‘token’ refers to a member's right to make such a reservation in view of his or her membership contract. The process then moves to strep S220 whereby the member can view the displayed calendar in order to make decisions about reservations. The process then moves to step S225.

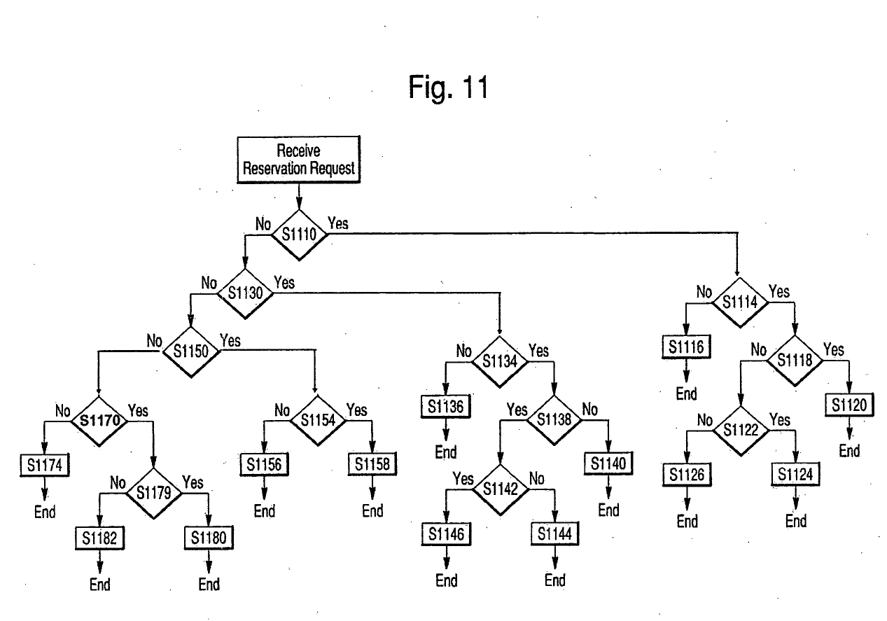

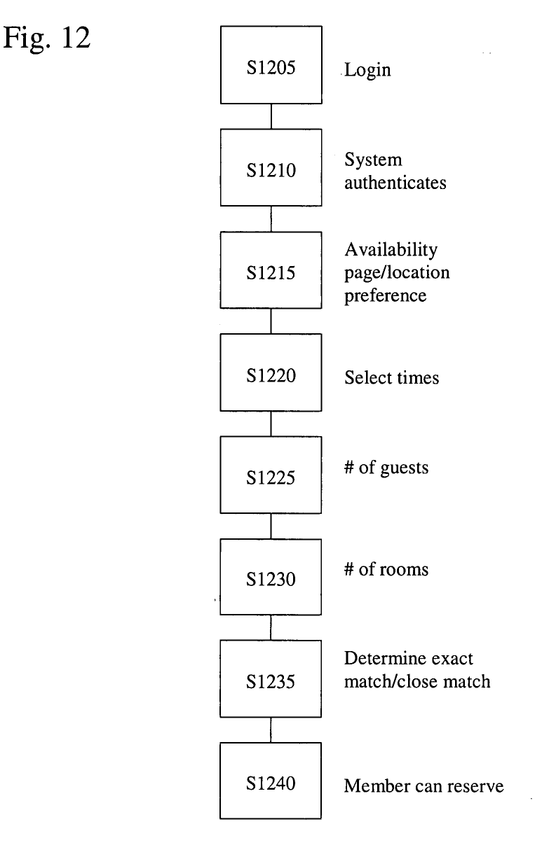

In step S225, the member can make a reservation by selecting both the specific property to be reserved and the preferred reservation dates. The reservation may also be of a specific reservation type, such as space available reservation, an advanced reservation or a non-priority or priority holiday reservation. The process then moves to step S230. In step S230, the system receives the member reservation request and compares the request against the member's contract. This step is described in greater detail below in conjunction FIG. 11, but generally involves examining the member's contract to determine what types of reservations a member may be eligible to make as well as well as the timing of the reservation request. The process then goes to step S235. In step S235, the system determines whether the member's reservation request can be granted based upon the comparison of step S230 as well as based upon the availability of the requested residence. These two processes can occur concurrently or one after the other. If the reservation request cannot be granted, the process moves to step S240 where the member is notified that the reservation request cannot be fulfilled because it is not allowed by the member's contract. The process then returns to step S215 where the member can view other properties. If, in step S235, the system determines that the member's request can be fulfilled, then the process moves to step S245 where the member is notified that the reservation can be made and the reservation is then booked. Additional functionality related to securing a reservation is also described below in conjunction with FIG. 12.

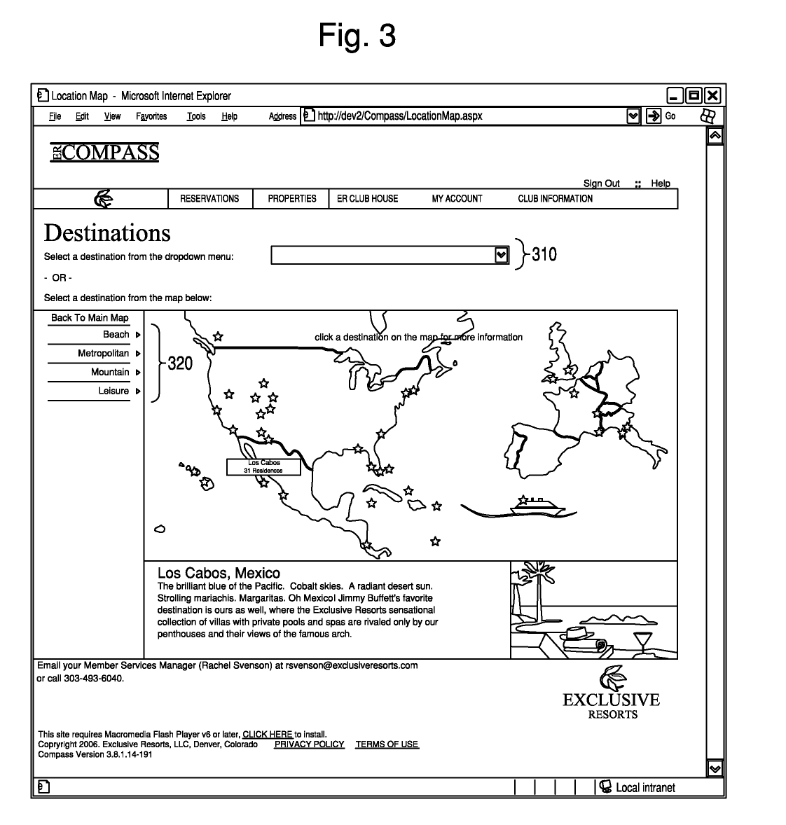

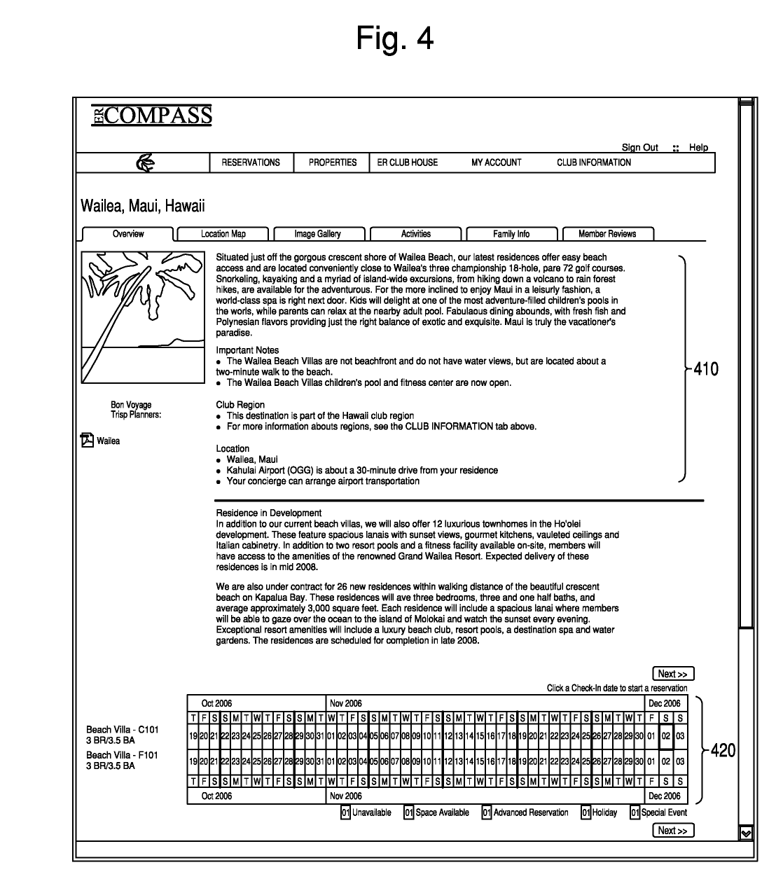

FIG. 3 shows a screen shot that may be presented to a member when the member chooses to learn more about certain residences, as was described in step S210 above. FIG. 3 shows a drop down menu 310 that a member can access to view specific residence destinations. FIG. 3 also shows categories 320 of residences, including “Beach,” “Metropolitan,” “Mountain,” and “Leisure” that a member can select for viewing prior to making a reservation. It is important to note that the invention allows members to view all properties responsive to a member query. In this way, members know all of the residence options that are available. FIG. 4 shows a screen shot of a specific destination as selected by a user. FIG. 4 includes an overview 410 of the destination, which may be accessed using the “overview” tab 430. The overview 410 may include a description of the residence and surrounding facilities and amenities. FIG. 4 also shows a calendar 420 which shows the available dates for reservation for the residences. FIG. 4 also shows a location map tab 440, an image gallery tab 450, an activities tab 460, a family information tab 470 and a member reviews tab 480. Members can access a map of the destination using the location map tab 440, images of the destination and residences using image gallery tab 450, a description of activities available at the destination using activities tab 460, information about family oriented activities and amenities using family information tab 470 and member reviews of the destination and residence using member reviews tab 480.

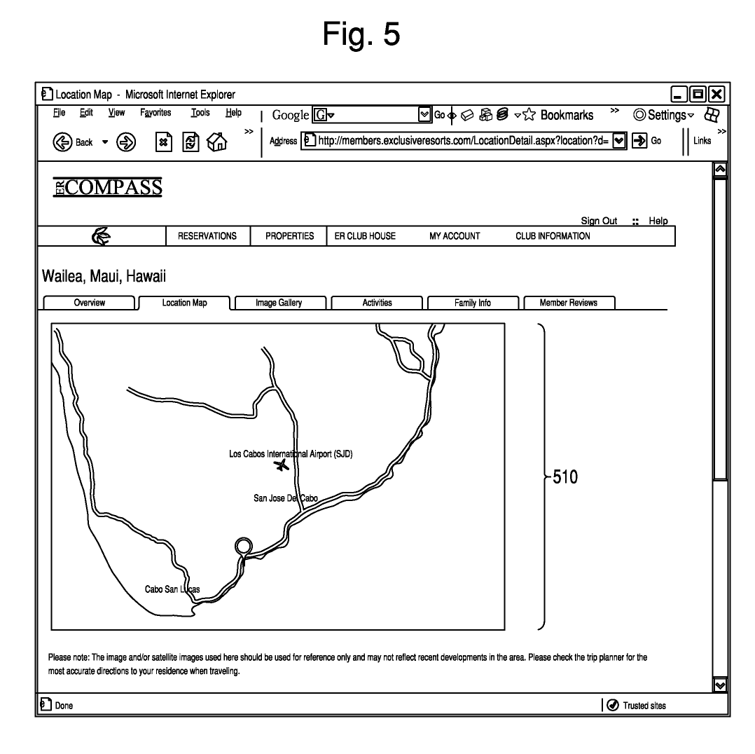

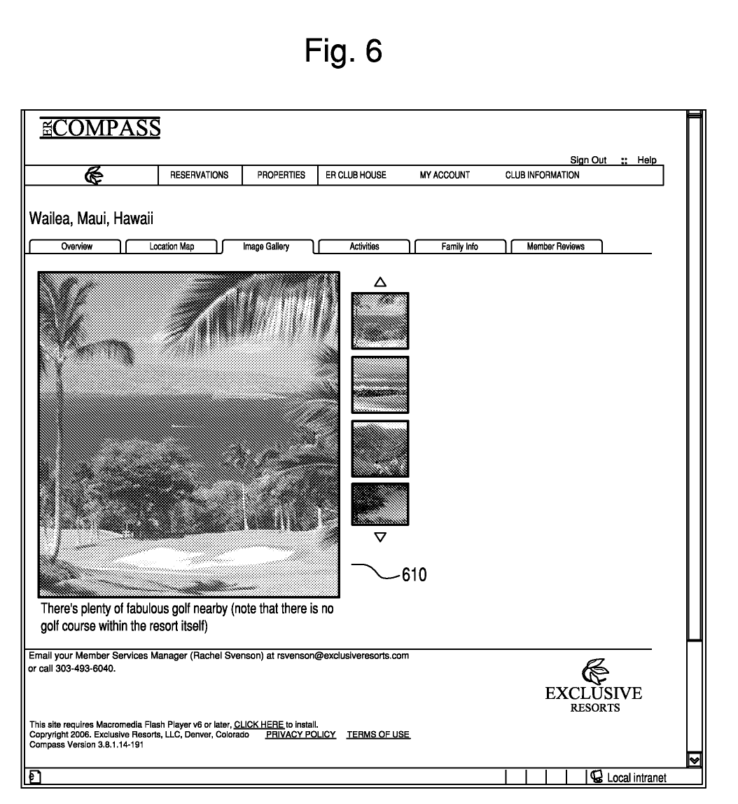

FIG. 5 is a screen shot of the location map that is displayed to the member when the location map tab 440 is selected. As shown in FIG. 5, a map 510 of the destination is displayed along. FIG. 6 is a screen shot of the destination images that are displayed to a member upon selecting the image gallery tab 450 shown in FIG. 4. As shown in FIG. 6, various photographs 610 and other images of the destination and residences can be displayed to the members.

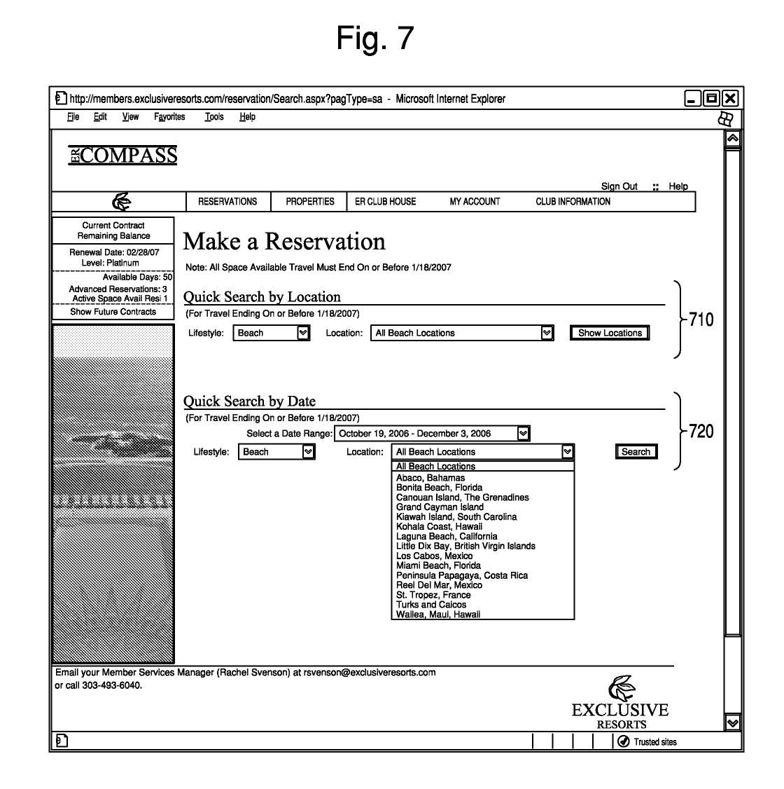

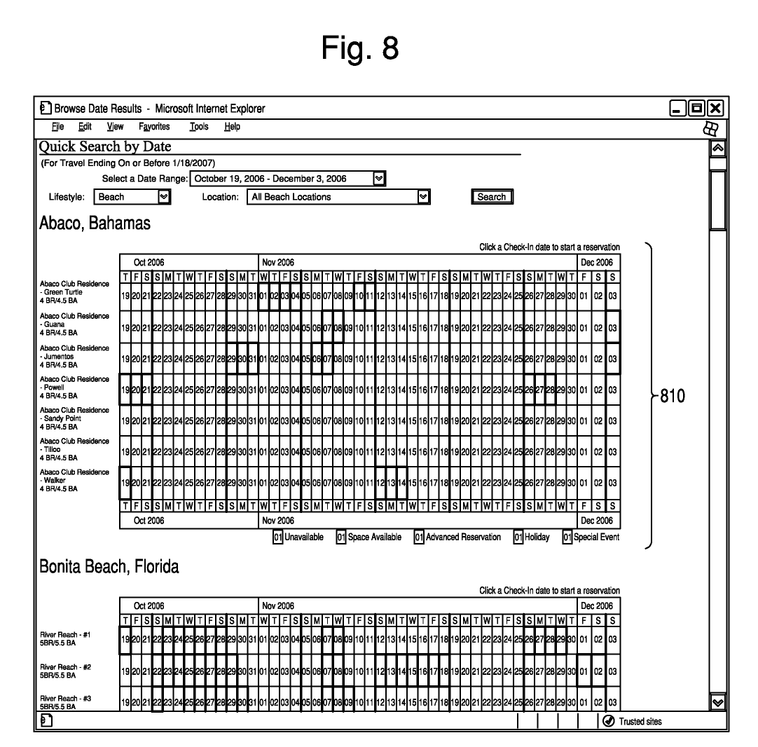

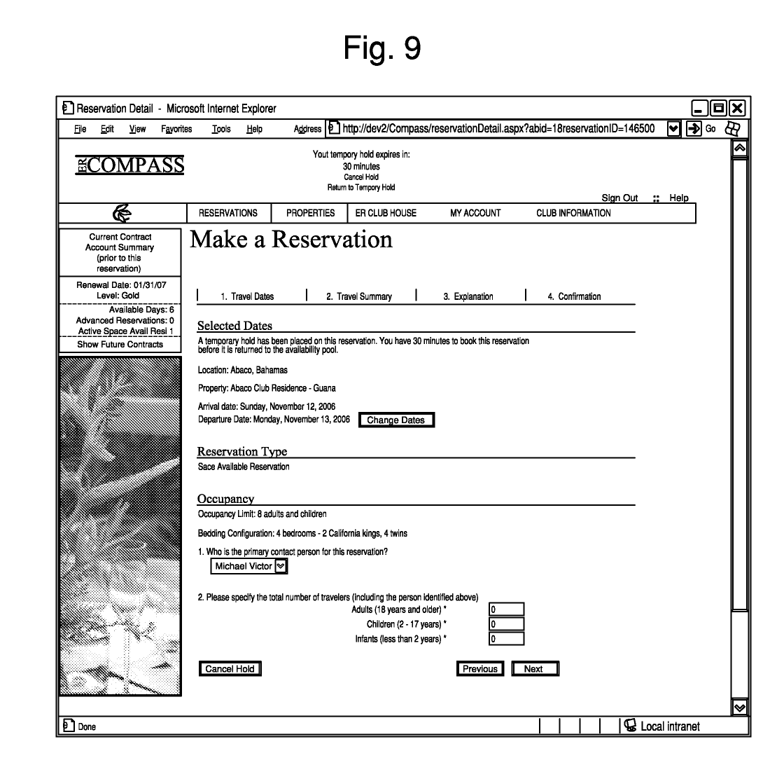

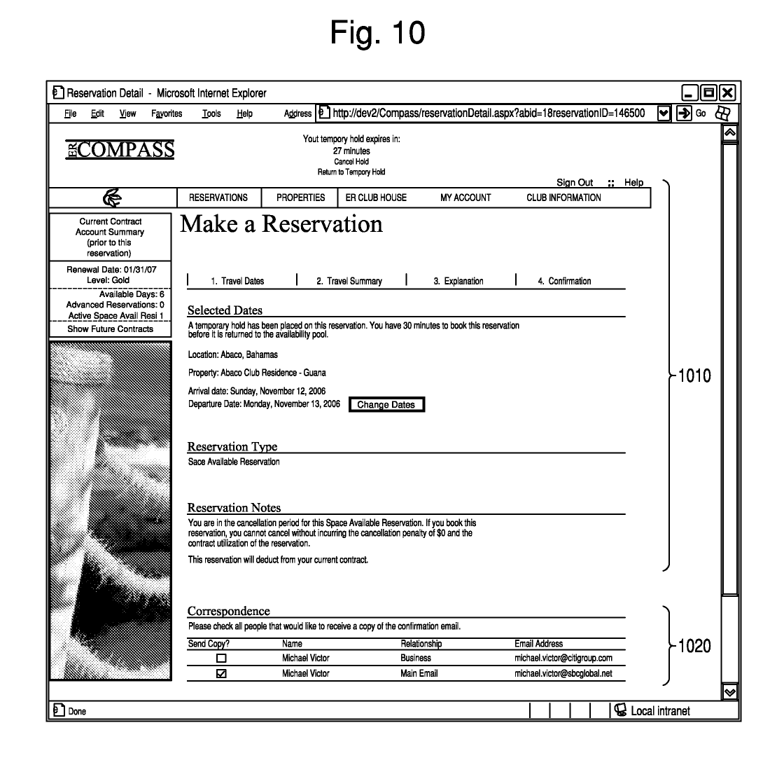

FIG. 7 is a screen shot showing the interface that is displayed to a member seeking to make a reservation. As shown in FIG. 7, members can search for a residence by location using lifestyle and location lists 710, or they can search for a residence by available date using the select a date range, lifestyle and location lists 720 using the pull down menus. FIG. 8 is a screen shot of a calendar 810 that is displayed to members after they have made a destination choice. The calendar 810 will show the dates when the selected residences are available. The displayed calendar 810 is an interactive calendar and shows the exact days when each specific residence is reserved and each day when each specific residence is available. Thus, a member is privy to the specific occupancy information for each residence viewable in a calendar format. A member can initiate a reservation request by clicking on an available day (a check-in/arrival day) on the calendar 810. Then, the member can select a check-out/departure date. According to one embodiment of the invention, days requiring advanced reservation tokens, non-priority holiday tokens and priority holidays may be color coded on the calendar 810 so that they are easily identified to the members. In this manner, members can select reservation dates using the calendar 810. FIG. 9 is a screen shot of a display after the member has selected start and end dates for his or her reservation. The system provides a notification 910 to the member that a temporary hold has been placed on the reservation while additional information is received about the member. The system also provides a notification 920 of the type of reservation. FIG. 9 also shows that occupancy information 930 is also provided to the member. The occupancy information may include an occupancy limit for the residence and may request from the member the total number of occupants expected. Once the occupancy information is received, the user is brought to a reservation summary screen 1010 as shown in FIG. 10. The summary screen provides the residence name and location, along with the selected arrival and departure dates. The reservation summary screen 1010 may also provide a summary of the residence type and notes regarding the reservation. The reservation summary screen 1010 may also inform the member of the cost of the reservation, including what the reservation may cost the member in tokens, etc. The summary screen also provides the member with the option of providing extra contact information, such as extra e-mail addresses for reaching the member. Finally, the reservation summary screen has a book reservation tab 1020 which allows the member to actually make the reservation.

As described in FIG. 2 above, at steps S230 and S235, the system in accordance with the invention checks the member's reservation request against their respective contract and then determines whether the requested reservation is permissible under their contract. This process and the logic associated with these steps are described in greater detail in conjunction with FIG. 11. In FIG. 11, the process begins at step S1105 where the system receives the reservation request from the member. This reservation request may include residence name and location, the type of reservation request being made (i.e., advanced, space available, non-priority holiday and priority holiday), selected dates for reservation, the number of guests, as well as other member preferences. The system in accordance with the invention then, beginning with step S1110, applies various reservations rules against the member's contract in order to determine whether the reservation request can be fulfilled. It should be understood that step S1110, S1130, S1150 and S1170 all relate to a determination of whether the requested reservation is allowed under the contract signed by the member. The subsequent steps, beginning with steps S1114, S1134, S1154 and S1174 all relate to a determination of whether the requested reservation is allowed in view of the member's previous reservation activity.

Returning to step S1110, the system determines whether the reservation request is a space available request. This is done by comparing the member's request against the space available windows that are defined in the member's contract. These windows may relate to whether the reservation request is being made within 90 days of the requested reservation. In another embodiment, the windows relate to those specific days on a calendar when a member is allowed to hold space available reservations in view of his or her contract. If it is a space available request, then the process moves to step S1114, otherwise the process moves to step S1130. In S1114, based upon the comparison step of S1110, the system determines whether the member's space available reservation request can be granted in view of his or her contract. If the space available reservation request cannot be met in view of the contract, the process moves to step S1116 where the member is notified that the reservation request cannot be fulfilled and that another request should be submitted. If in step S1114 the system determines that the requested space available reservation request can be met, the process then moves to step S1118. Beginning with step S1118, the system begins looking at previous reservations made by the member during the contract year. Thus, in step S1118, the system determines whether the member has less than the maximum number of concurrent space available reservations as defined under his or her contract. In other words, in this step, the system determines whether the member has more than the allowed number of space available reservations at a given time. If the system determines that the member already has equal to or more than the maximum number of concurrent space available reservations allowed as defined in his or contract, then the process moves to step S1120 where the member is notified that the space available reservation request cannot be fulfilled and that another type of reservation request should be made. If, on the other hand, in step S1118 the system determines that the member has sufficient space available reservation rights as defined in his or her contract, then process moves to S1122. In step S1122, the system determines whether requested reservation dates are for less than or equal to the remaining maximum number of days that the member is entitled. In other words, if the member's contract specifies a maximum number of days a member can reserve any property, then at this step the system determines whether the member's request would exceed such a maximum (for a given time frame, such as within a calendar year). If the system determines that the reservation is for more than the allowed maximum number of days, the process then moves to step S1124 where the member is notified that the reservation request cannot be fulfilled and that another reservation request should be made. Alternately, in step S1122, if the system determines that the requested reservation is less than the allowed maximum number of days, then the process moves to step S1126. In step S1126, the system notifies the member that his or her reservation request can be fulfilled and the reservation is booked. The process then ends.

Returning to step S1130, the system determines whether the requested reservation is an advanced reservation request by comparing the advanced reservation request date to the advanced reservation date windows provided in the member's contract. If the reservation request is not an advance reservation request, the process moves to step S1150. Otherwise, the process moves to step S1134. In step S1134, the system determines, based upon the comparison in step S1130, whether the member's requested advanced reservation dates can be granted based upon the days allowed in the member's contract (i.e., does the member's contact allow them to make advanced reservation requests on the requested days or are they blocked out because of the member's membership tier). If the advanced reservation request cannot be granted based upon the contract, then the process moves to step SI 136 where the member is notified that the reservation request cannot be fulfilled and that another reservation request should be made. On the other hand, if in step S1134, the system determines that the advanced reservation request can be granted, then the process moves to step S1138.

In step S1138, the system determines whether the member has sufficient advanced reservation tokens left to allow the requested reservation. If the system determines that the member does not have sufficient advanced reservation tokens, the process moves to step S1140 where the member is notified that the reservation request cannot be fulfilled and that another request should be submitted. Alternatively, if in step S1138 the system determines that the member does have sufficient advance reservation tokens, the process then moves to step SI 142.

In step S1142, the system determines whether the member has less than the maximum number of advanced reservations remaining under his or her contract. If the member does not have less than the maximum number of advanced reservations, then the process moves to step S1144 where the member is notified that the reservation request cannot be fulfilled and that a new reservation request should be submitted. If in step S1142 the system determines that the member does have less than the maximum number of advanced reservations remaining, the process will then move to step S1146 where the member is notified that the reservation request can be fulfilled and the reservation is then booked. The process then ends.

Turning to step S1150, the system determines whether the requested reservation is a non-priority holiday reservation request by comparing the member's non-priority holiday request against the non-priority holiday window from the member's contract. This refers to the number of non-priority holiday reservations days that a member is permitted to make. If the reservation request is a non-priority holiday request, the process moves to step S1154. If the reservation request is not a non-priority date request, then the process moves to step S1170. In step S1154, the system utilizing the comparison made in step SI 150, determines whether the member's non-priority holiday reservation request can be granted in view of the member's contract (i.e., does the member's contract allow non-priority holiday reservation requests to be made on the selected days and/or does the member have sufficient days (advanced reservation tokens) left under his or her contract to allow such a non-priority holiday reservation request). If the non-priority holiday reservation request cannot be granted, the process moves to step S1156 where the member is notified that the reservation request cannot be fulfilled and that the member must submit a new reservation request. If in step S1154, the system determines that the non-priority reservation request can be granted, the process then moves to step S1158 where the reservation request is granted.

In an alternate embodiment, at step S1158, the system determines whether the member has sufficient non-priority date tokens in order to make the requested reservation. If the system determines that the member does not have sufficient tokens to make the non-priority date reservation request, the member is notified that the reservation request cannot be fulfilled and that another reservation request should be submitted. If in step S1158 the system determines that the member does have sufficient tokens for making the non-priority date reservation request, then the system determines whether the member has less than their maximum number of non-priority date window reservations remaining. If the system determines that the member has not requested less than their maximum number of non-priority date reservations, then the member is notified that the reservation request cannot be fulfilled and that a new reservation request should be submitted. Alternatively, if the system determines that the member has requested less than their maximum number of non-priority date reservations, then the system notifies the member that the reservation request can be fulfilled and the reservation is then booked. The process then ends.

Returning to step S1170, at this point, the system has determined that the reservation request is not a space available reservation, not an advanced reservation and not a non-priority holiday reservation request, and thus it must be a priority holiday date reservation request. In step S1170, the system compares the priority holiday date reservation request against the priority holiday date windows allowed under the member's contract. If the priority holiday reservation request cannot be granted, the process moves to step S1174 where the member is notified that the reservation request cannot be granted and that another reservation request should be submitted. If in step S1170 the system determines that the priority holiday reservation request can be granted, the process moves to step S1179. In step S1179, the system determines whether the member has sufficient priority holiday tokens left in order to make the requested holiday reservation and whether the member has the right to book the type of priority holiday reservation selected. In one embodiment, in this step, the system may also determine whether the requested reservation exceeds total number of reservations days that the member has remaining. If in the step S1179, the system determines that the member does not have sufficient priority holiday tokens remaining and does not have the right to book the selected holiday, then the process moves to step S1182 where the member is notified that the reservation request cannot be fulfilled and that a new reservation request should be submitted. Alternately, if in step S1179 the system determines that the member does have sufficient holiday tokens remaining to make the requested reservation and has the right to book the selected priority holiday, then the process moves to step S1180 where the member is notified that the priority holiday reservation request has been accepted and reservation is then booked. The process then ends.

Thus as described above in connection with FIG. 11, the invention provides for various rules which govern whether a reservation request can or cannot be granted. In addition to the rules described in conjunction with FIG. 11 above, the system may provide several additional rules. For example, in one embodiment of the invention, the system will determine whether a member has cancelled reservations at a residence that they are attempting to book for the same dates. In this embodiment, a member may not be allowed to make reservations in a residence for which he or she has already cancelled a reservation. In another embodiment of the invention, the system determines whether the requested reservation overlaps with an existing reservation. In one embodiment of the invention, a member may not be allowed to make overlapping reservations. In another embodiment of the invention, a member will be allowed to make overlapping reservations but is notified of such an overlap in case the reservation was made in error. In another embodiment of the invention, the system examines whether the reservation is for a sponsored guest. If the reservation is for a sponsored guest, the system determines whether that particular guest is permitted within the residence. In addition, the system determines whether the member will owe any additional money in order to reserve the residence on behalf of a sponsored guest.

FIG. 12 illustrates in greater detail the process for determining the availability of a residence in view of a member's preferences in accordance with one embodiment of the invention. This functionality allows members to search for available residences based upon location, lifestyle and/or travel dates and may be carried out by the reservations application 160 shown in FIG. 1. In FIG. 12, the process begins with step S1205. In step S1205, a member logs into the system seeking to locate a residence. The process then moves to step S1210 where the system authenticates the member. In addition to verifying that the person logging into the system is a member, in this step, the system may also retrieve the member's profile which may include various information about that particular member. The process then moves to step S1215.

In step S1215, the member is presented with an availability search page and has the option of selecting a specific destination, a specific residence and/or a residence that matches a certain lifestyle choice. The process then moves to step S1220. In step S1220, the member can select a preferred travel time, which may include a range of arrival and departure dates, or alternatively specific arrival and departure dates. This may also include specifying Friday or Saturday night stays. The process then moves to step S1225 where the member can provide the number of guests that will be using the residence. The process then moves to step S1230, where the members can indicate a minimum number of rooms that they will require in a residence. The process then moves to step S1235. In any of the steps 1215, 1220, 1225 and 1230, the member may also be assisted by member service staff who also have access to the member's profile information and can view the member's residence preferences and criteria.

In step S1235, the system determines which properties exactly match the member selections described above. An exact match would mean that one or more properties have been located which exactly match the member's preferences for location, lifestyle, number of rooms, number of consecutive nights, as well as any other date requirements submitted by the member. In one embodiment of the invention, the displayed results include a summary of how may residences in each requested location were located, a link to the selected residences, as well a description of the type of residence, the residence name, the availability dates and other residence details.

In step S1235, the system is also able determine properties that closely match a member's search request. In one embodiment of the invention, the system determines an overall percentage match between the member's request and the actual residence located. This allows members to quickly evaluate how close the “close match” residence is to member's request. The percent or close match can be calculated as follows: for a non-match of the number of bedrooms requested, deduct 5%; for a non-match of the number of consecutive nights requested, deduct 5%; for a non-match of the lifestyle request, deduct 25%; for a non-match of the destination, deduct 20%; for a non-match of a request to include a Thursday night stay, deduct 15%; for a non-match of a request to include a Friday night stay, deduct 15%; for a non-match of a request include a Saturday night stay, deduct 15%; for a non-match of a request to include a full week, deduct 15%. In this manner, the system in accordance with the invention is able to calculate a percentage match. It should be noted that the percentages described above are applicable to one embodiment of the invention but are customizable and can be varied by the residence management group. In addition to the percentage match, the member is shown the residence names for the close matches, as well as the residence type, the availability dates, as well as other residence details. The process then moves to step S1240. In step S1240, the members can reserve those properties from the list of displayed exact and close matches.

It should be noted that the residence management staff, sales staff and concierges can also assist members with determining the availability of residences. In accordance with the invention, when a member contacts a residence management staff person or concierge seeking assistance, the staff or concierge can view the same interface that the member views. This allows the staff person or concierge to better assist the member.

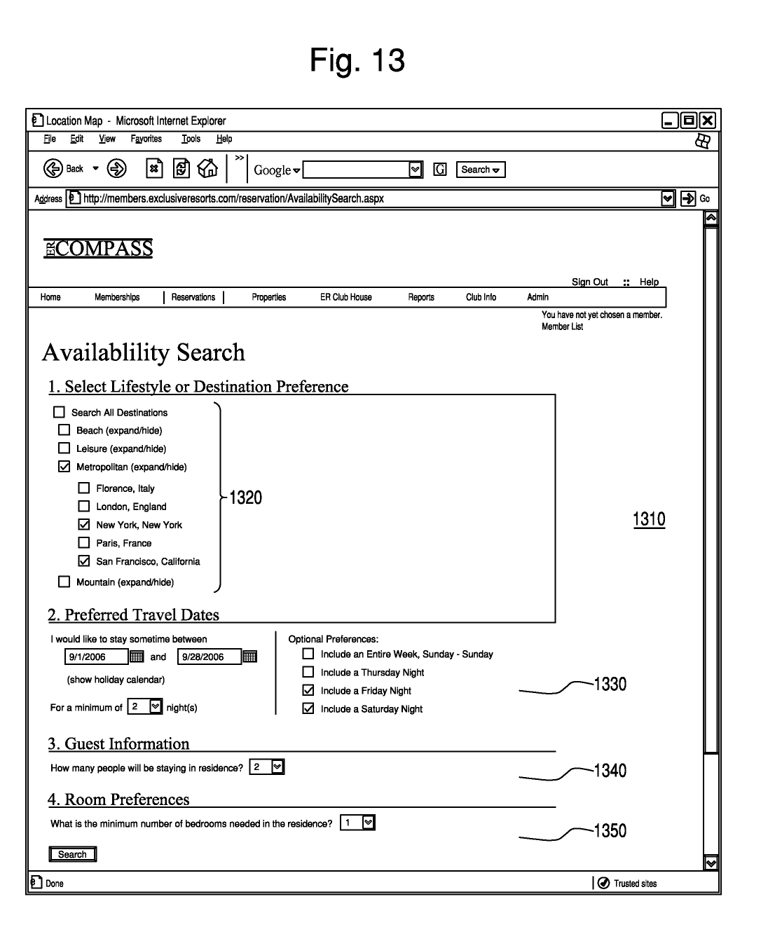

FIG. 13 illustrates a sample screen shot for an interface allowing members to search the availability of certain properties. FIG. 13 shows an availability search page 1310 that includes a “Select Lifestyle or Destination Preferences” area 1320. The area 1320 allows members to search all destinations or those related to a certain lifestyle/geography (i.e., beaches, mountains, etc.). FIG. 13 also shows a “Preferred Travel Dates” area 1330. In area 1330, the member can select preferred arrival and departure dates, as well as a range of acceptable dates. Additional preferences, such as including certain nights or full weeks or weekends can be entered in the area. FIG. 13 also shows a “Guest Information” area 1350 where members can provide the number of people staying at the residence. Finally, a “Room Preference” area 1360 is provided where the member can indicate a minimum number of rooms desired. After completing each of these queries, the member can submit his or her request and it will be acted on as described above in order to locate both exact matches and close matches.

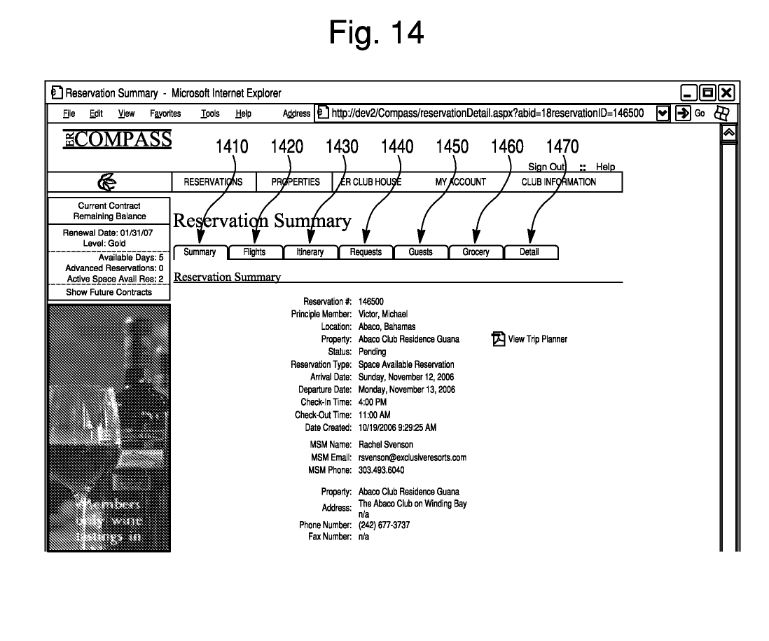

As described above, the communications and feedback application 140 shown in FIG. 1 provides various functionalities for members. These include a reservations information function, a properties function, an ER Club House function, a “my account” function and a Club information function. FIG. 14 shows a screen shot of the reservation information function of the embodiment of the invention. As shown in FIG. 14, when a member selects the reservation information function, the following tabs appear: Summary 1410, Flights 1420, Itinerary 1430, Requests 1440, Guests 1450, Grocery 1460 and Detail 1470. The screen shown in FIG. 14 shows the case where the Summary tab 1410 has been selected. Thus, a summary of a member's reservation is provided. As shown in FIG. 14, the reservation summary may include a reservation number, the member's name, the location of the reserved residence, the name of the residence, information regarding the reservation type, arrival and departure dates, along with check-in and check-out dates, as well as contact information for the member and the member services manager or concierge who is designated to assist the member. All of the information provided by the reservation information function can assist members along with member service managers and concierges whose task is to assist the member with any questions or requests that they may have.

FIG. 14 also shows a Flights tab 1420 that provides a summary of the flight information for the member. The flight information will correspond to that member's reservation plans. FIG. 14 also shows and Itinerary tab 1430 that will provide a summary of the member's itinerary including a daily plan of events if the member has created an event plan. FIG. 14 also shows a Requests tab 1440 that shows any special requests made by the member. FIG. 14 also shows a Guest tab 1450 that provides a listing of the guests who are registered to stay at the residence. FIG. 14 also shows a Grocery tab 1460 that can be completed by the member or the member's guests and may include a comprehensive list of groceries and other items that the member and his or her guests would like to have available upon arrival. Typically, the concierge will attend to monitoring the grocery list to make sure that it is properly fulfilled. Finally, a Details tab 1470 can provide additional information that may be relevant to the member's stay.

FIG. 14 also shows a Properties tab which allows members to view information about various destinations and residences. This properties function mirrors the functions described above in conjunction with FIGS. 3-10 which allows members to view various details about properties both before and after making a reservation.

FIG. 14 also shows an “ER Club House” function that provides a member community homepage which describes various services available to members also provides a summary of the member's contract and reservation information. The member community homepage also provides the residence management with a location to communicate new information to members. The member homepage also includes a member discussion forum. The member discussion forum is a place where members can post messages and replies in a discussion board format. In accordance with the invention, the member discussion forum is restricted to only those members of the property management solution. For ease of navigation, the discussion forums may be organized by lifestyle and destination to allow for organized discourse. All of the various discussion threads may be organized by lifestyle, destination and/or property group. Members can then pick a specific forum and view the various discussion threads in that forum. Various sub-forums can also be created which may be grouped by destination or property group. Members can read posts within a specific forum or sub-forum and also post comments for discussion directly to a forum or a sub-forum. In order to create a post, a member first decides in which forum or sub-forum he or she would like to place to posting. Once the member has decided the forum or sub-forum, he or she can create the message for posting. In accordance with the invention, the member has various additional options including restricting replies to the post, which prevents other members from replying directly to the post. Members can also request that all replies to the post be automatically e-mailed to them. This means that a member can keep track of and view replies to a post without having to log into the member services page. Once a member has created a post and has made his or her selections regarding the handling of replies, he or she can then post the message to the appropriate forum or sub-forum. Members also have the option of previewing a post before it is placed into the selected forum.

Members have various options when viewing posts. These options include viewing a summary of the thread or topic being discussed in a group of postings. Members can also print out an entire thread, search for specific words within a thread, create an email to members if any new posts are added to a thread and a sort threads by a number of different criteria. Members also have the option of replying to posts as well as reporting certain posts as inappropriate. In accordance with the invention, members can also create private messages that are available only to other authorized members. This can be accomplished by first creating a post and then indicating that the post should be available to only selected members. The member forum functionality described above allows members to communicate with one another about topics of interest to the participating members.

The invention also provides a restaurant review functionality which allows members to easily locate and share information about restaurants located close to residences. Members can write and post restaurant reviews that can be viewed by other members. In addition, the property management staff and concierge can also post their own restaurant reviews. A member seeking restaurant reviews may first be directed to a restaurant review search page. Using the search page, a member can first select a location and then provide additional criteria if desired. After clicking the search button, the member is presented with the names of all restaurants entered into the system that match the supplied search request. At this point, members can further filter the list of restaurants using various criteria including: type of cuisine and/or various price points. The list of restaurants will include the restaurant name, addresses, contact information, hyperlinks to more information about the restaurant including the restaurant's website and a hyperlink to a mapping feature which shows the precise location of the restaurant. The restaurant listing may also include a description of the cuisine, a description of the pricing, as well as other considerations, including whether children are welcome. Members can also view an average overall member rating of each restaurant. This is an average rating based upon ratings submitted by member for individual restaurants. Members can also click on the rating to view specific reviews by various members. The system also allows users to map out the locations of each of the listed restaurants. The system also provides a restaurant detail page where members can learn more about a specific restaurant including concierge tips and other information. Members are also provided with additional links including, whether the review is helpful, which provides an opportunity to track which reviews are most helpful. Members are also provided an opportunity to write a review. Members may write and post one review per restaurant and can select the number of stars they want to give a restaurant based upon various factors including the food service, ambiance and overall experience. The invention also allows members the opportunity to add restaurants to the list. A member can provide the name, location and a brief description of a restaurant that he or she would like added to the list.

Another functionality provided through the member community page is an “Ask Management” functionality which allows members to submit queries to the property management about management policies, expansion plans or any other questions that have to do with the property management group. Members have the option to click on a “submit a question” button which will automatically create an e-mail directed to the property management group. The member simply types in his or her question and can expect a response by the residence management group. The member has the option of having his or her response posted or directly emailed to his or her private email account.

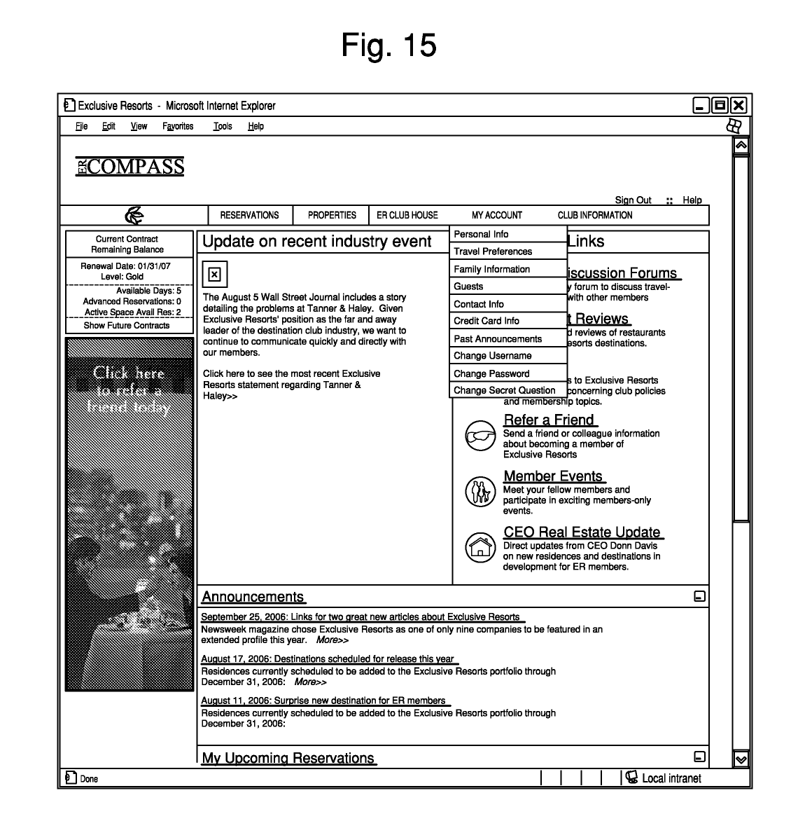

Returning to FIG. 14, the system also provides a “My Account” function that can be accessed using the “My Account” tab. FIG. 15 shows a “My Account” drop down menu that is displayed when the “My Account” tab is selected. The “My Account” function allows members to view and manage their information. For example, members can provide and update their personal information, including names and addresses; provide their travel preferences, including listing activities of interest to various family members; provide family information; and provide a list of guest who they frequently travel with. The “My Account” function may also include contract information, including details about how many days, advanced reservation tokens and/or holiday tokens a member has at any given moment. In this manner, a member can keep track of his contract status. The “My Account” function may also include a member's credit card information, past announcements and a location for members to manage their login information.

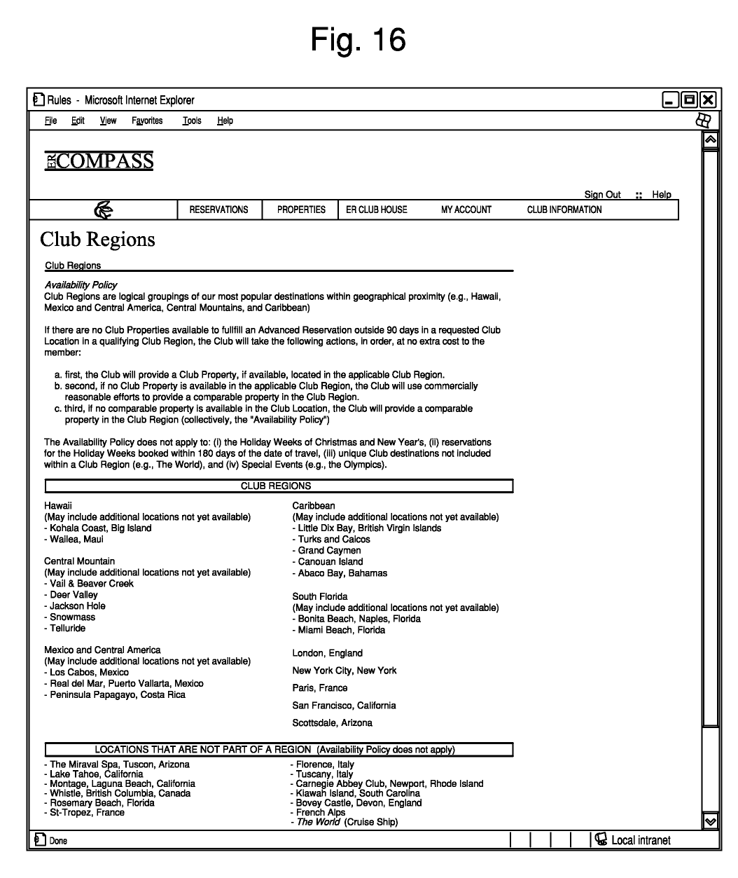

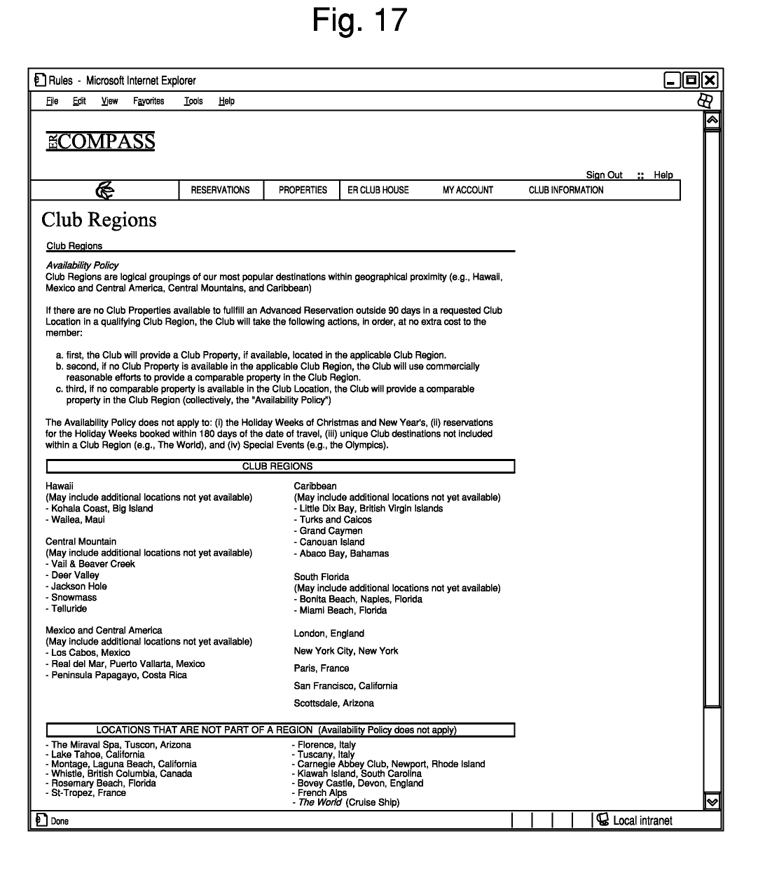

Returning to FIG. 14, a “club information” tab is also provided which provides members with helpful information. FIG. 16 shows a club information drop down menu 1610. Using the club information tab, members can access a variety of information about the destination club, including a membership summary which shows the current membership plans includes costs and setup; clubs regions, which describes regions in club that are included in the guaranteed reservation clause; cancellation policy which provides a reminder of the club's cancellation policy; daily usage fees which explains how some of the destinations require a daily usage fee; holidays and special events, which lists all of the holiday dates and special events for the destination club which will affect whether a guarantee will be in place for a residence and if it will require a holiday token to stay there; member steering committee, which meets and makes recommendations and provides feedback on the club to club management from a member perspective; in-residence rules, which relates to rules that the club has for members when staying in a residence; partnerships, which lists partnerships between the destination club and other organizations. FIG. 17 shows a screen shot of the club regions page which describes the different regions having destination clubs and a description of those regions.

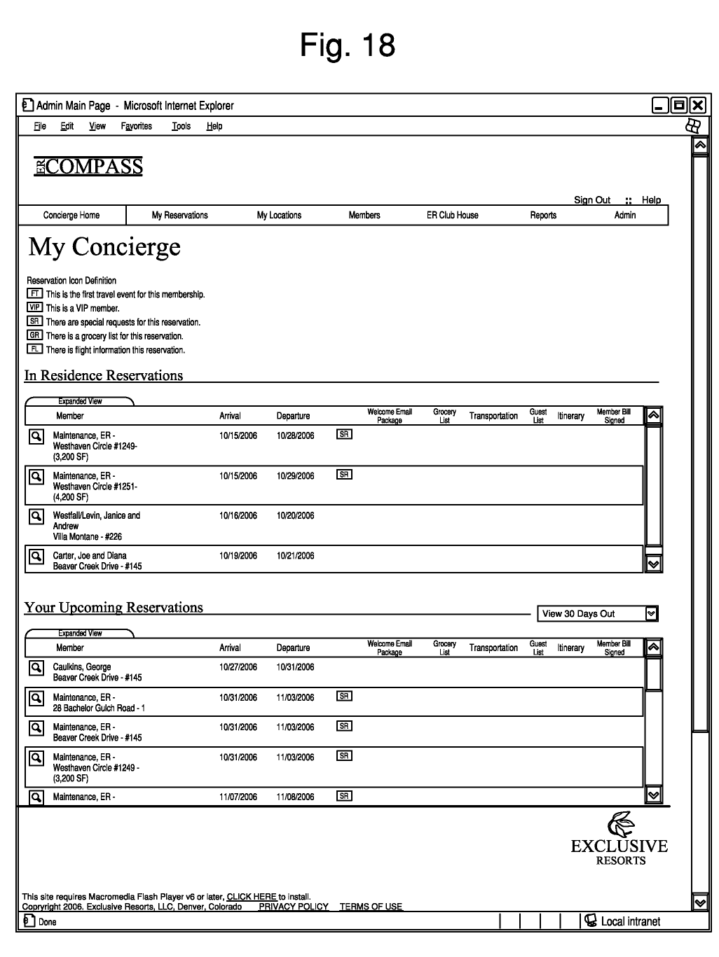

FIG. 18 shows a screen shot which includes a “concierge” tab. Using this tab, the residence concierge can manage the member's reservation once it has been made and also provide other assistance to the member and his or her guests. As shown in FIG. 18, a “My Concierge” screen is displayed which shows all of the reservations made by a member and includes arrival and departure dates as well as any other information or requests that a member has submitted. The “My Concierge” screen also displays additional notes that will assist the concierge with providing services to members. For example, FIG. 18 shows a “welcome e-mail package,” a “grocery list,” a “transportation,” a “guest list,” an “itinerary” and a “member bill signed” section for notation. FIG. 18 also shows various icons that may be displayed next to each reservation. These icons may reflect whether the reservation is for a first time traveling member, a VIP member or whether the member has a special request, has supplied a grocery list or has provided their flight information.

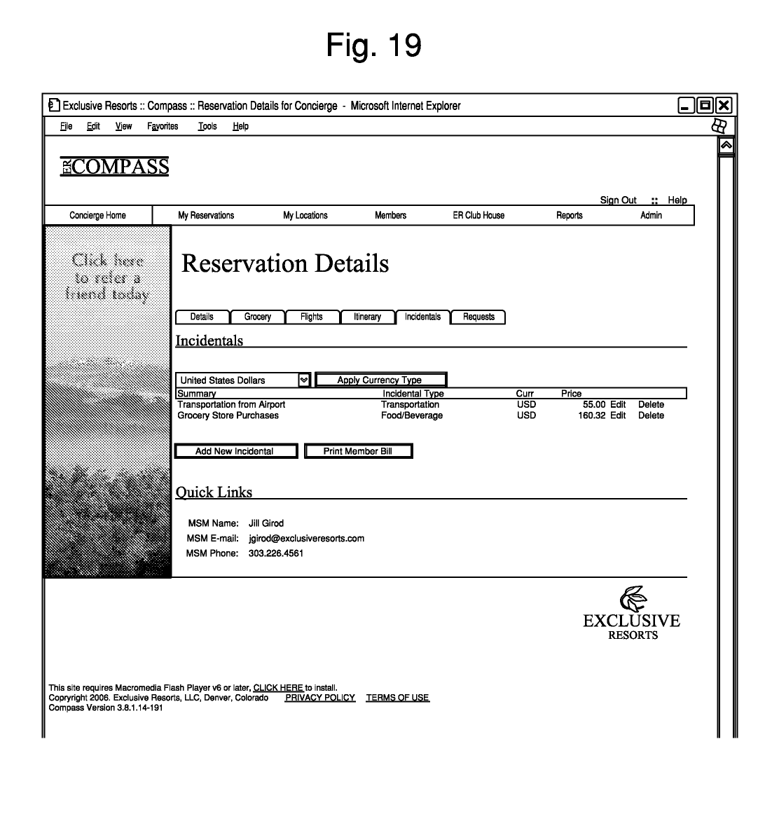

FIG. 19 illustrates an additional feature available to the concierge which provides the ability to track all charges that a member or his or her guests may incur during their stay at a residence. As shown in FIG. 19, each incidental is tracked including a description of the incidental, its category and its cost that will be charged to the member. This can be provided to the member for payment at the end of his or her stay.

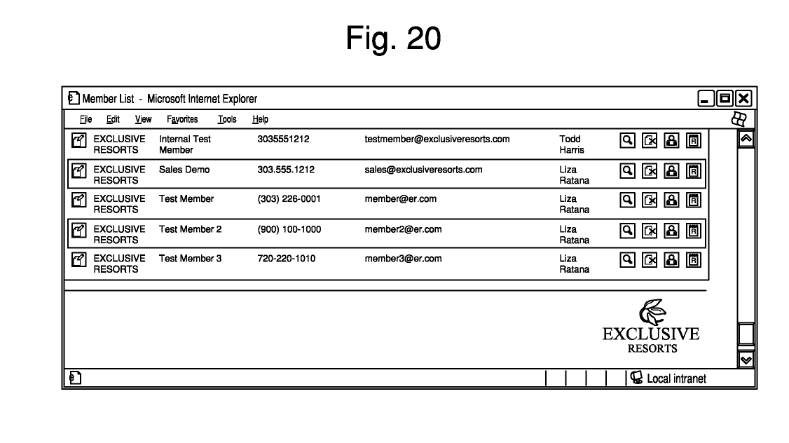

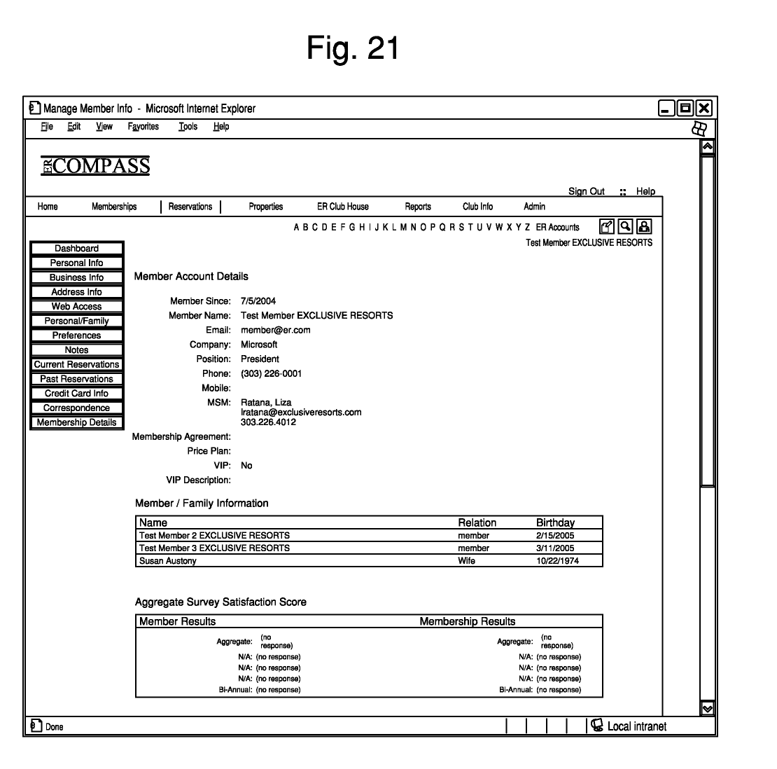

As described earlier, member services managers provide a wide variety of services to member starting at the point of making reservations. FIG. 20 illustrates an interface available to member services managers. For example, FIG. 20 shows the names of each member, their contact information, their membership type. FIG. 21 shows an interface displayed to the member services managers after they have clicked on specific member. FIG. 21 includes specific information about the member, including their preferences, family information and reservations history. Member services managers can also view a summary of the each member's contracts.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

1. A method for determining the availability Destination Club residences for reservation, comprising the steps of:
receiving a reservation request for a Destination Club residence from a member, the reservation request including a property type preference and preferred dates of stay;
determining whether there are any exact matches for the received request;
determining whether there are any close matches for the received request; and
displaying the exact matches and the close matches.

2. The method according to claim 1, wherein the property type preference includes at least one of a lifestyle preference, a destination preference and a specific property preference.

3. The method according to claim 1, wherein the step of determining whether there are any close matches includes calculating a percentage match to the received request.

4. The method according to claim 3, wherein the percentage match=100[(−5% for a non-match of the number of bedrooms requested,), and (−5% for a non-match of the number of consecutive nights requested)and (−25% for a non-match of the lifestyle request), and (−20% for a non-match of the destination ), and (−15% for a non-match of a request to include a Thursday night stay), and (−15% for a non-match of a request to include a Friday night stay), and (−15% for a non-match of a request include a Saturday night stay), (−15% for a non-match of a request to include a full week)].

5. The method according to claim 1, wherein the received reservation request is one of a space available reservation request, an advanced reservation request, a non-priority holiday reservation request and a priority holiday reservation request.

6. A method for reserving Destination Club residences, comprising the steps of:
receiving at least one request for a reservation of a Destination Club property from a Destination Club member, the at least one request including a property type preference and preferred dates of stay;
determining whether the request for reservation is permissible under a member's contract; and
granting the reservation request if the request is permissible under a member's contract.

7. The method according to claim 6, wherein the received reservation request is one of a space available reservation request, an advanced reservation request, a non-priority holiday reservation request and a priority holiday reservation request.

8. The method according to claim 7, wherein each of the space available reservation request, advanced reservation request, non-priority holiday reservation request and priority holiday reservation request is governed by a member's contract.

9. The method according to claim 7, wherein the advanced reservation request allows a member to reserve a Destination Club residence more than 90 days in advance and is guaranteed.

10. The method according to claim 7, wherein the space available reservation must be made within 90 days of the arrival date and is not guaranteed.

11. The method according to claim 10, wherein a member is permitted to have only two space available reservations at a given time.

12. The method according to claim 7, wherein the non-priority holiday reservation grants the member a right to reserve residences on certain pre-determined holidays.

13. The method according to claim 7, wherein the priority holiday reservation grants the member a right to reserve residences on all holidays.

14. The method according to claim 8, wherein each member's contract provides a total number of reservation days permitted within a calendar year, a total number of advanced reservation requests permitted within a calendar year, a total number of non-priority holiday reservation requests permitted within a calendar year and a total number of priority holiday reservation requests permitted within a calendar year.

15. The method according to claim 7, wherein the step of determining whether the request for reservation is permissible further includes:
identifying whether the reservation request submitted by the member is one of a space available reservation request type, an advanced reservation request type, a non-priority holiday reservation request type and a priority holiday reservation request type;
evaluating whether reservation request submitted by the member is permitted under a member's contact;
determining whether the member has exceeded the number of reservation days allocated under a member's contract for the reservation type.

16. The method according to claim 7, wherein the step of determining whether the request for reservation is permissible further includes:
determining whether the received request is a space available request, and if so, determining whether the space available request can be granted in view of a member's contact, determining whether a member has less than the maximum number of concurrent space available reservations as defined in their contract and determining whether requested reservation dates are for less than or equal to the allowed maximum number of days that the member is entitled;
determining whether the received request is an advanced reservation request, and if so, determining, whether the member's requested advanced reservation request can be granted in view of the member's contract, determining whether the member has sufficient advanced reservation tokens to allow the requested reservation and determining whether the member has less than the maximum number of advanced reservation tokens;
determining whether the received request is a non-priority holiday reservation request, and if so, determining whether the non-priority reservation request can be granted in view of the member contract, determining whether the member has sufficient non-priority date tokens in order to make the requested reservation and determining whether the member has requested less than their maximum number of non-priority date window reservations.
determining whether the received request is a holiday date reservation request, and if so, determining whether the holiday reservation request can be granted in view of the member contract, determining whether the member has sufficient holiday tokens left in order to make the requested reservation and determining whether the member has a right to book the type of holiday selected.

17. A system for managing Destination Club properties, comprising:
a processor; and
a database,
the processor configured to provide a communications and feedback application which provides a platform for communications between members of the Destination Club and Destination Club management staff and concierge personnel;
a member profile application which generates a profile of each member based upon at least one of a member's membership plan, destination preferences and lifestyle preferences; and
a reservations application which can determine the availability of residences requested by members and secure reservations for members.

18. The system according to claim 17, wherein the communications feedback application allows members to post inquiries, information, restaurant reviews and requests for services and amenities in an on-line forum accessible to only members.

19. The system according to claim 17, wherein the communications and feedback application includes an overview function, a map function, a calendar function, an image gallery function, an activities function, a family activities function and a member reviews tab.

20. The system according to claim 17, wherein the member profile application may continuously update the member profile based upon information received from the member.

21. The system according to claim 17, wherein the member profile application assigns a membership tier for each member.

22. The system according to claim 17, wherein the reservations application receives requests for reservations from members, the requests for reservations including a property type preference, preferred dates of stay and at least one of a number of people staying at the facility and a minimum number of rooms.

23. The system according to claim 17, wherein the reservations application determines whether there are any exact matches for the received request and whether there are any close matches for the received request.

24. The system according to claim 17, wherein the reservation application displays an interactive calendar for all Destination Club residences that allows members to view all available and reserved dates for each Destination Club residence and allows the members to initiate a reservations process by selecting an arrival date on the interactive calendar.

25. The system according to claim 17, wherein the reservations application accepts at least one of a space available reservation request, an advanced reservation request, a non-priority holiday reservation request and a priority holiday reservation request.
